(19) United States
(12) Patent Application Publication
(10) Pub. No.: US 2009/0040904 A1
(43) Pub. Date: Feb. 12, 2009

(54) Laser Driving Device, Optical Head Incorporating Laser Driving Device, and Optical Disk Apparatus

(76) Inventors: Toshio Matsumoto, Kyoto (JP); Hisashi Senga, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 10/595,693

(22) PCT Filed: Nov. 15, 2004
(86) PCT No.: PCT/JP04/16929

§ 371 Date: May 5, 2006

(30) Foreign Application Priority Data
Nov. 18, 2003 (JP) 2003-387889

(51) Int. Cl. G11B 7/135

(52) U.S. Cl. 369/112.23; G9B/7.112

(57) ABSTRACT

Provided is a semiconductor laser driving device which enables to reduce unnecessary power consumption.

The laser driving device includes: a laser driving section for supplying a driving current for causing a semiconductor laser to emit light; a temperature detecting section for detecting a temperature of the semiconductor laser; and a voltage control section for supplying a source voltage to the laser driving section while changing a voltage value of the source voltage in accordance with the temperature detected by the temperature detecting section. As a result, unnecessary power consumption can be reduced. An appliance having the aforementioned information laser driving device will make energy savings possible, and further make it possible to suppress temperature increases of the appliance.

### TECHNICAL FIELD

The present invention relates to a laser driving device for driving a semiconductor laser. More specifically, the present invention relates to a laser driving device for writing data on a storage medium such as an optical disk and reading data written thereon, and an apparatus having such a laser driving device.

### BACKGROUND ART

A large number of apparatuses have been developed which employ a semiconductor laser to record information on and reproduce information from a storage medium. Among such apparatuses, optical disk apparatuses are drawing great attention as apparatuses that are capable of coping with the increase in information amounts in the recent years.

An optical disk apparatus has an optical head, and supplies a current to a semiconductor laser which is mounted in the optical head to cause the semiconductor laser to emit light. When reproducing information, the optical disk apparatus converges weak reproduction light on the disk to read information which is recorded on the optical disk in the form of marks, pits, etc., based upon reflectance, angles of deviation, or the like. When recording or erasing information, the optical disk apparatus supplies a larger current to the semiconductor laser than when reproduction is performed, thus causing the semiconductor laser to emit light with a large light amount (high power). As a result, a physical change is caused in the material on the optical disk, whereby information is recorded in the form of marks, pits, etc., or the existing information is erased.

FIG. 1 shows a commonly-used connection structure for driving a semiconductor laser. When supplied with a voltage (Vld) from a power source 3, a laser driving section 2 supplies the current from the power source 3 to the semiconductor laser 1. Based on this current, the semiconductor laser 1 emits light with a power which is in accordance with the size of the current.

In FIG. 1, a voltage which is necessary for the laser driving section 2 to operate is represented as an “operating voltage Vtr”, whereas a voltage which is necessary for the semiconductor laser 1 to operate is represented as an “operating voltage Vop”. Note that the operating voltage Vop is a voltage, between an anode and a cathode, which is necessary for causing the semiconductor laser 1 to emit light.

In order for the semiconductor laser 1 to emit light, the respective voltages must satisfy the following formula.

Vld≧Vop+Vtr (Formula 1)

Herein, the laser operating voltage Vop varies in accordance with a current (laser driving current) which is flown in the semiconductor laser, for example.

FIG. 2 is a graph showing the laser driving current-laser emission power characteristics A (Iop-P characteristics A) and the laser driving current-laser operating voltage characteristics B (Iop-Vop characteristics B) of a semiconductor laser. As shown by the Iop-P characteristics A, the emission power of a semiconductor laser varies in accordance with the laser driving current. Therefore, by controlling the value of the driving current (Iop), it is possible to cause the semiconductor laser to emit light with a desired power. On the other hand, as shown by the Iop-Vop characteristics B, the laser operating voltage Vop varies from Vop0 to Vop2 in accordance with the laser driving current. Therefore, the laser can adequately emit light across the entire current range so long as the voltage of the power source which supplies power to the laser driving section 2 is:

Vld≧Vop2+Vtr. (Formula 2)

However, power will be wastefully consumed if a source voltage Vld that satisfies formula 2 is always supplied irrespective of the value of the laser driving current (or the laser operating voltage). Specifically, when the laser driving current Iop is small (e.g., Iop=Iop1 (FIG. 2)), a laser operating voltage of Vop1 would suffice; however, a power of Iop1×(Vop2−Vop1) will be wastefully consumed because formula 2 assumes the laser operating voltage to be Vop2.

Regarding this problem, a technique of switching the voltage to be supplied to the laser driving section in a stepwise manner, in accordance with the operating voltage of the laser, is disclosed in Patent Document 1, for example.

FIG. 3 shows the functional block construction of a conventional semiconductor laser driving device 300. Based on an instruction from a user, a power setting section 306 outputs a setting instruction signal b. It is assumed that the setting instruction signal b is variable depending on the mode of operation, i.e., recording of information or reproduction of information. Based on an output value (i.e. an instruction value) from a laser power control section 307, a laser driving section 302 causes a driving current to flow through a semiconductor laser 301.

When the semiconductor laser 301 emits laser light, a portion thereof enters a photodetector 303. The photodetector 303 outputs a current of a size which is in accordance with the power of the received light, that is, the emission power of the semiconductor laser 301. A current-voltage converter 304 converts the output current from the photodetector 303 into a voltage signal. Note that the photodetector 303 and the current-voltage converter 304 together compose an emission power detecting section 305. From the emission power detecting section 305, a power detection signal a which represents the emission power of the semiconductor laser 301 is output.

The laser power control section 307 controls the instruction value for the laser driving section 302 so that the power detection signal a becomes equal to a reference voltage signal b. As a result, the current amount of the laser driving current that is supplied from the laser driving section 302 to the semiconductor laser 301 can be controlled, whereby the emission power of the semiconductor laser 301 is controlled so as to be appropriate for both reproduction of information and recording of information.

On the other hand, an operating voltage detecting section 308 detects the operating voltage value Vop of the semiconductor laser 301, and sends it to a voltage selection section 309. In accordance with the voltage value of the laser operating voltage Vop which has been detected in the operating voltage detecting section 308, the voltage selection section 309 selects a voltage Vc to be supplied to the laser driving section 302, and sends it to a voltage control section 310. The voltage control section 310, which is composed of a DC/DC converter, for example, supplies the selected voltage Vc to the laser driving section 302.

Now, with reference to FIG. 4, an example method by which the voltage Vc is selected in the voltage selection section 309 will be described. FIG. 4 shows a determination procedure in a conventional voltage selecting process.

At step S41, the voltage selection section 309 compares the current operating voltage Vop against the first voltage Vop1. If the result of the comparison indicates that the operating voltage Vop is equal to or greater than the predetermined voltage Vop1, control proceeds to step S42; if the operating voltage Vop is equal to or greater than the predetermined voltage Vop1, control proceeds to step 43.

At step S42, the voltage selection section 309 selects a voltage Vc=Vop2+Vtr, which corresponds to the maximum estimated value Vop2 of the operating voltage Vop. On the other hand, at step S43, the voltage selection section 309 selects Vc=Vop1+Vtr. As a result, unnecessary power consumption can be reduced.

[Patent Document 1] Japanese Laid-Open Patent Publication No. 2000-244052

### DISCLOSURE OF INVENTION

### Problems to be Solved by the Invention

However, the conventional construction has a problem in that it requires dedicated component elements for detecting the operating voltage of the semiconductor laser (e.g., the operating voltage detecting section 308 in FIG. 3), thus leading to an increased cost. Moreover, a space for installing such component elements will be needed on the optical head having the semiconductor laser mounted thereon, which would become a hindrance in downsizing.

Furthermore, since the voltage Vc to be supplied to the laser driving section is switched in a stepwise manner, it has been difficult to supply an optimum voltage Vc at all times. The reason is that, if a conceivable method for switching the voltage Vc were to be adopted, i.e., dividing a predetermined voltage in such a manner that the ratio of voltage division is variable, a number of resistors corresponding to the number of steps in the voltage Vc would be required; in practice, switching in only a few steps can be realized.

### Means for Solving the Problems

An object of the present invention is to provide a semiconductor laser driving device which makes enables to reduce unnecessary power consumption without requiring dedicated component elements.

A laser driving device according to the present invention includes: a laser driving section for supplying a driving current for causing a laser to emit light; a temperature detecting section for detecting a temperature of the laser; and a voltage control section for supplying a source voltage to the laser driving section while changing a voltage value of the source voltage in accordance with the temperature detected by the temperature detecting section.

The laser driving device may further include a power control section for causing the laser to emit light with a predetermined emission power by controlling an instruction value for the laser driving section so as to adjust the driving current which is supplied from the laser driving section.

The laser driving device may further include a setting section for instructing a setting of a reference voltage in accordance with an amount of light to be emitted by the laser.

The laser driving device further includes an emission power detecting section for detecting a value which is in accordance with the emission power of the laser and outputting a signal corresponding to the value. The power control section may control the instruction value to the laser driving section based on a voltage of the signal which is output from the emission power detecting section and the reference voltage, in such a manner that the voltage of the signal equals the reference voltage.

Characteristics between an operating voltage necessary for the laser to operate and the driving current differ depending on temperature. The voltage control section may determine the voltage value of the source voltage based on the driving current and the characteristics.

The operating voltage may increase as the temperature decreases; and the voltage control section may supply a higher source voltage as the temperature decreases.

The laser driving section may output a driving current for causing a laser whose wavelength is within a range from 400 nm to 430 nm to emit light.

An optical head according to the present invention is used for performing a data write and/or read operation with respect to an information recording layer of a storage medium. The optical head includes: a laser; a laser driving device for supplying a driving current for causing the laser to emit light; an objective lens for converging light from the laser onto the information recording layer; and a light-receiving section for receiving light reflected from the information recording layer and for outputting a signal which is in accordance with the amount of light. The laser driving device includes: a temperature detecting section for detecting a temperature of the laser; and a voltage control section for supplying a source voltage to the laser driving section while changing a voltage value of the source voltage in accordance with the temperature detected by the temperature detecting section.

An optical disk apparatus according to the present invention is used for performing a data write and/or read operation with respect to an information recording layer of an optical disk. The optical disk apparatus includes: an optical head for radiating light toward the optical disk, and generating and outputting a servo signal based on light which is reflected from the information recording layer; a control signal generating section for generating a control signal for controlling the position of a focal point of the light based on the servo signal which is output from the optical head; and a driving circuit for generating a driving signal based on the control signal. The optical head includes: a laser; a laser driving device for supplying a driving current for causing the laser to emit light; an objective lens for converging light from the laser onto the information recording layer; an actuator for adjusting a position of the objective lens based on the driving signal; and a light-receiving section for receiving light reflected from the information recording layer and for outputting a signal which is in accordance with the amount of light. Furthermore, the laser driving device includes: a temperature detecting section for detecting a temperature of the laser; and a voltage control section for supplying a source voltage to the laser driving section while changing a voltage value of the source voltage in accordance with the temperature detected by the temperature detecting section.

A laser driving method according to the present invention includes the steps of: supplying a driving current for causing a laser to emit light; detecting a temperature of the laser; and supplying a source voltage when executing the step of supplying the driving current, a voltage value of the source voltage being changed in accordance with the detected temperature.

### EFFECTS OF THE INVENTION

According to the present invention, there is provided a driving device for a semiconductor laser which makes it possible to reduce power consumption without requiring any new component elements. An appliance having the driving device according to the present invention will make energy savings possible, and further suppress temperature increases. As such an appliance, for example, an optical disk apparatus which performs a data write and read operation with respect to an optical disk by using a blue-violet laser light would be suitable. In particular, a mobile-type appliance (e.g., a mobile optical disk apparatus) which is under severe requirements concerning temperature increase suppression and power savings of the appliance would be suitable.

### BRIEF DESCRIPTION OF DRAWINGS

FIG. 1 A diagram showing a commonly-used connection structure for driving a semiconductor laser.

FIG. 2 A graph showing the laser driving current-laser emission power characteristics A (Iop-P characteristics A) and the laser driving current-laser operating voltage characteristics B (Iop-Vop characteristics B) of a semiconductor laser.

FIG. 3 A diagram showing the functional block construction of a conventional semiconductor laser driving device 300.

FIG. 4 A diagram showing a determination procedure in a conventional voltage selecting process.

FIG. 5 A diagram showing the functional block construction of an optical disk apparatus 50 according to an embodiment of the present invention.

FIG. 6 A diagram showing the functional block construction of a laser driving device 10 according to an embodiment of the present invention.

FIG. 7 A diagram showing the functional block construction of a laser power control section 12.

FIG. 8 A graph showing the laser driving current-laser operating voltage characteristics (Iop−Vop characteristics) of a blue-violet semiconductor laser with respect to temperature.

FIG. 9 A diagram showing the circuit construction of a temperature detecting section 21 and a voltage control section 22.

FIG. 10 (a) a graph showing the temperature characteristics of a resistance value Rth of a thermistor 21; and (b) a graph showing the temperature characteristics of an output voltage of the voltage control section 22.

FIG. 11 A diagram showing the construction of a laser driving section 20.

FIG. 12 A flowchart showing a procedure of processing by the optical disk apparatus 50.

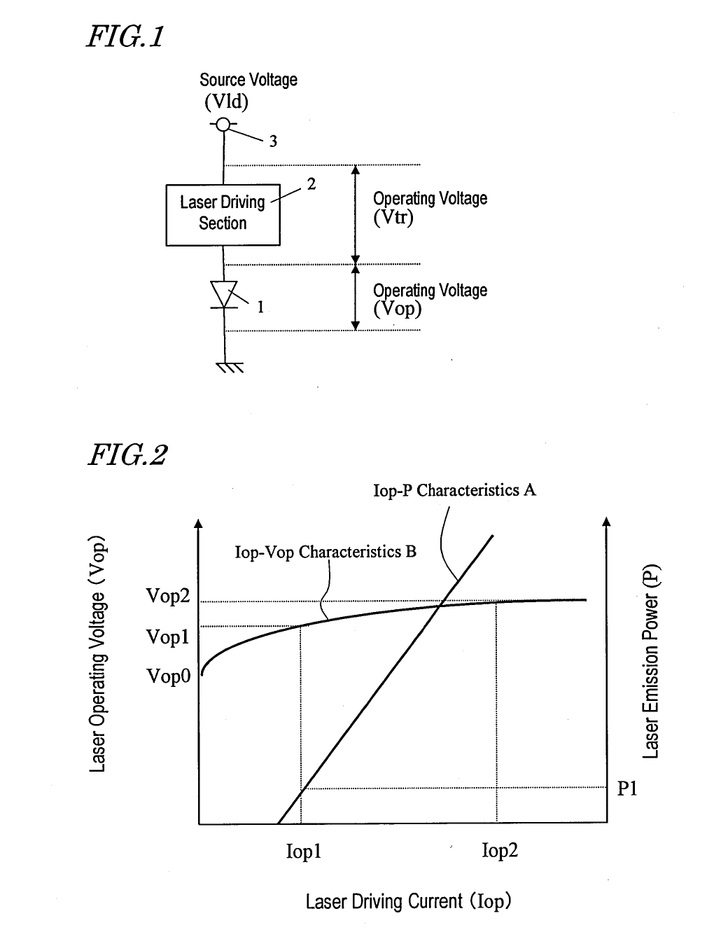

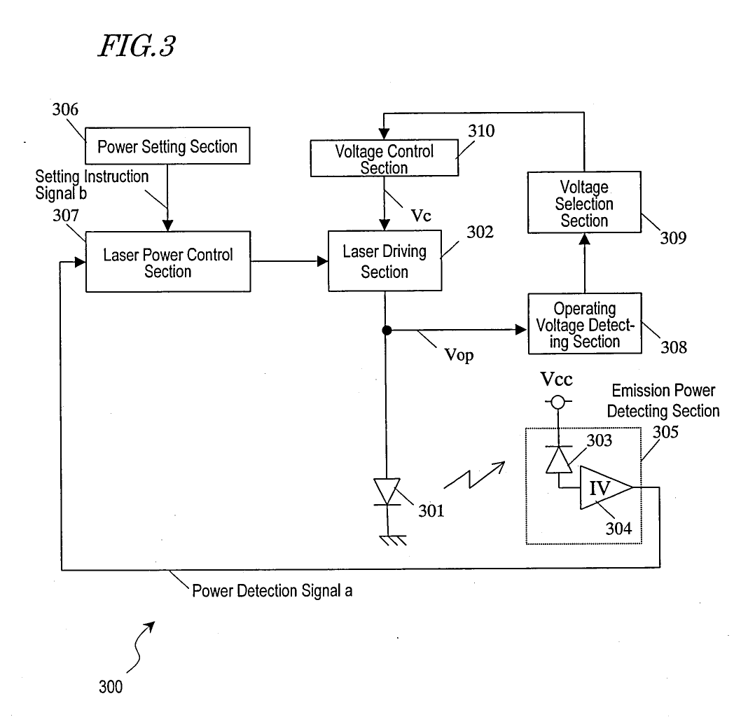

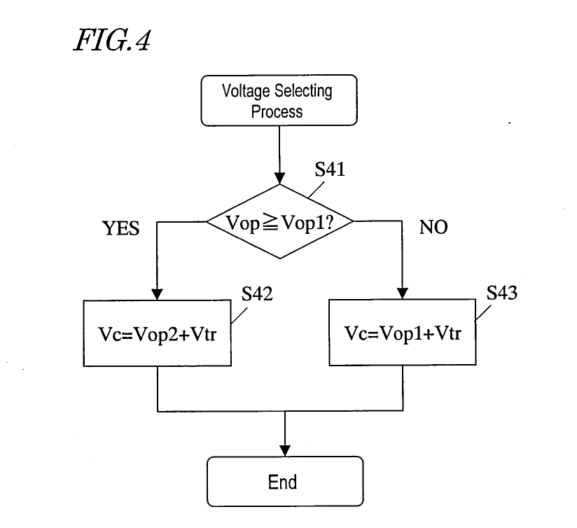

### DESCRIPTION OF THE REFERENCE NUMERALS

1 semiconductor laser
7 light-receiving section
8 current-voltage converter
10 laser driving device
11 power setting section
12 laser power control section
20 laser driving section
21 temperature detecting section
22 voltage control section
24 emission power detecting section
50 optical disk apparatus
52 optical head
54 control signal generating section
56 driving circuit
58 reproduction processing section
60 optical disk

### BEST MODE FOR CARRYING OUT THE INVENTION

Hereinafter, with reference to the accompanying figures, an embodiment of the present invention will be described.

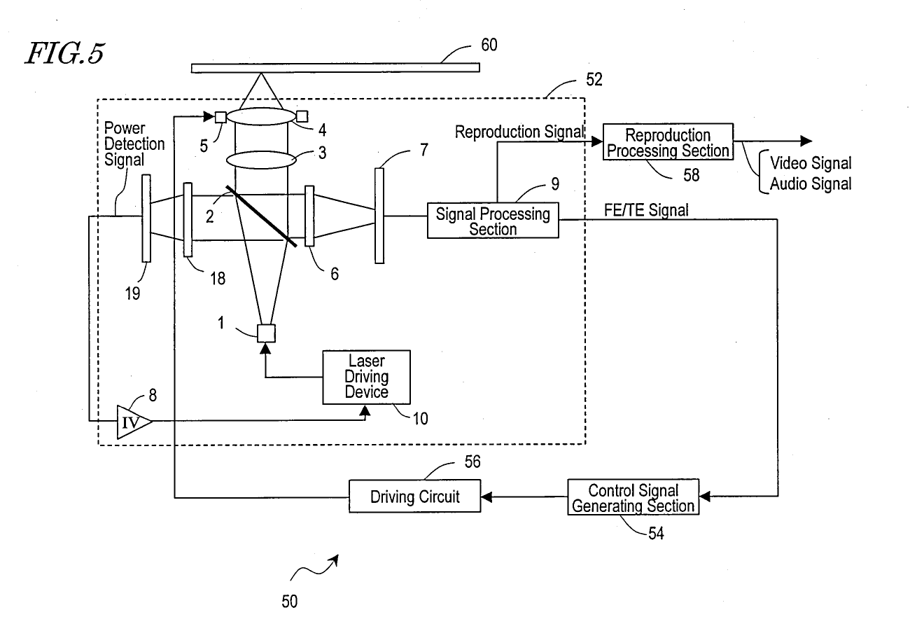

FIG. 5 shows the functional block construction of an optical disk apparatus 50 according to the present embodiment. The optical disk apparatus 50 is capable of performing data write and/or read operation for an optical disk 60. For example, the optical disk apparatus 50 is a mobile-type video reproduction appliance for reproducing a movie which is recorded on an optical disk, or a camcorder for recording video and audio onto an optical disk.

As the optical disk 60, a BD (Blu-ray Disc) is contemplated, for example. Although an optical disk will be illustrated in the present specification, any optical information storage medium, e.g., a card, which is capable of optical data read and write is also applicable, for example.

The optical disk apparatus 50 includes an optical head 52, a control signal generating section 54, a driving circuit 56, and a reproduction processing section 58.

The optical head 52 has an optical system which radiates laser light toward the optical disk 60, and receives reflected light therefrom. The optical head 52 performs control for changing the focal point of light along a radial direction and a normal direction of the optical disk 60 so as to be accurately positioned on a track on the optical disk 60. While this control is being performed, a data write and/or read operation is performed for the optical disk 60. The construction of the optical head 52 will be specifically described later. Although FIG. 5 illustrates the optical disk 60 for convenience of description, it must be noted that the optical disk 60 is not a component element of the optical disk apparatus 50. The optical disk 60 is mounted to the optical disk apparatus 50, and taken out from the optical disk apparatus 50.

Based on servo signals which are output from the optical head 52, e.g., a tracking error signal (TE signal) and a focus error signal (FE signal), the control signal generating section 54 generates a control signal for controlling the relative positioning between a light spot of laser light and a track on the optical disk 60 with respect to the radial direction and the normal direction. The control signal which is output from the control signal generating section 54 is supplied to the driving circuit 56. Based on the received control signal, the driving circuit 56 generates a driving signal, and applies it to an actuator 5 (described below) or a transport stage (not shown) of the optical head 52. They respectively cause the objective lens 4 and the entire optical head 52 to be moved along the radial direction and normal direction of the optical disk 60, thus adjusting the relative position between the light spot of laser light and a track on the optical disk 60. While servo control such as focusing control and tracking control is being stably performed, the reproduction processing section 58 performs a predetermined reproduction process with respect to the reflected light from the optical disk 60, and outputs video and audio signals for reproduction.

Next, the construction of the optical head 52 will be described. The optical head 52 includes a semiconductor laser 1, a beam splitter 2, a collimating lens 3, an objective lens 4, an actuator 5, a diffraction element 6, light-receiving sections 7 and 19, a current-voltage converter 8, a signal processing section 9, a laser driving device 10, and a converging lens 18.

The semiconductor laser 1 is a light source which outputs blue-violet laser light having a wavelength of 405 nm, for example. This wavelength value does not need to be exact, but may be in the range from 400 nm to 415 nm, or in the range from 400 nm to 430 nm, for example. It is preferably in the range of 405±5 nm.

The beam splitter 2 transmits a portion of the light, while reflecting the remainder. The collimating lens 3 collimates the light from the semiconductor laser 1 into parallel light. The objective lens 4 converges the laser light which has been radiated from the semiconductor laser 1, so as to form a focal point at a predetermined distance. The diffraction element 6 receives light which is reflected from the optical disk 60, and diffracts a portion of the light through a predetermined diffraction region.

The light-receiving section 7 has a plurality of light-receiving regions, each light-receiving region outputting a photocurrent of a size which is in accordance with the light amount of the received light. Based on the photocurrent, the signal processing section 9 generates a tracking error signal (TE signal), a focus error signal (FE signal), a reproduction signal, and the like. The TE signal represents an offset between the light spot position of laser light and a desired track on the optical disk 60 along the radial direction of the optical disk 60. The FE signal represents an offset between the light spot position of laser light and an information recording layer of the optical disk 60 along the normal direction of the optical disk 60.

A portion of the light having been radiated from the semiconductor laser 1 enters the converging lens 18, which converges a light beam at the light-receiving section 19. The light-receiving section 19 outputs a photocurrent of a size which is in accordance with the received light amount. The current-voltage converter 8 converts the photocurrent output from the light-receiving section 19 into a voltage, and outputs it as a power detection signal a.

Next, the process which is performed in the optical head 52 will be described, along the light path. Most of the light which is radiated from the semiconductor laser 1 is transmitted through the beam splitter 2, collimated by the collimating lens 3 into parallel light and then enters the objective lens 4, and is converged by the objective lens 4 onto the information recording layer of the optical disk 60.

The light which is reflected from the optical disk 60 again passes through the objective lens 4 and the collimating lens 3 to enter the beam splitter 2. The light which is reflected from the beam splitter 2 enters the diffraction element 6, where a plurality of rays of light are obtained through diffraction. Each light-receiving region of the light-receiving section 7 receives the light having been split by the diffraction element 6. Each light-receiving region outputs a photocurrent which is in accordance with the amount of received light.

The photocurrent which is output from the light-receiving section 7 is sent to the signal processing section 9. The signal processing section 9 generates a TE signal and an FE signal based on the photocurrent. Based on the TE signal and FE signal, a control signal is generated in the control signal generating section 54, with which tracking control and focusing control are realized. Since it is well known as to how the FE signal and TE signal are generated and how the positions of the objective lens 4 and the optical head 52 are adjusted based on these signals, the descriptions thereof are omitted here.

On the other hand, a portion of the light which has been radiated from the semiconductor laser 1 is reflected by the beam splitter 2, enters the converging lens 18, and is converged by the converging lens 18 onto the light-receiving section 19. A photocurrent which is output from the light-receiving section 19 is sent to the current-voltage converter 8. The photocurrent is converted by the current-voltage converter 8 into a voltage, and sent to the laser driving device 10. Based on this light amount, the laser driving device 10 controls the current amount flowing through the semiconductor laser 1 and its voltage value.

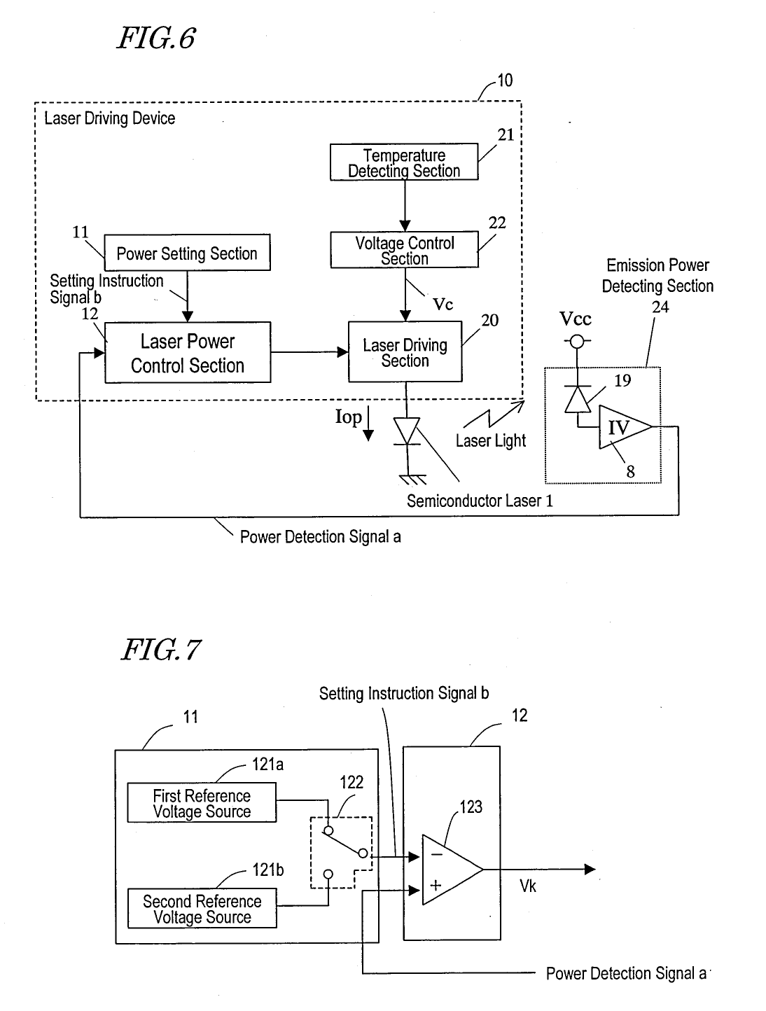

Next, with reference to FIG. 6, the detailed construction of the laser driving device 10 will be described. FIG. 6 shows the functional block construction of the laser driving device 10 according to the present embodiment. In FIG. 6, the light-receiving section 19 and the current-voltage converter 8 are collectively shown as an emission power detecting section 24.

The laser driving device 10 includes a power setting section 11, a laser power control section 12, a laser driving section 20, a temperature detecting section 21, and a voltage control section 22.

Among these component elements, the laser driving section 20 allows a driving current to flow through the semiconductor laser 1 based on a value (instruction value) which is output from the laser power control section 12. Therefore, those component elements which are related to the laser power control section 12 will be described, followed by descriptions of those component elements which are related to the voltage control section 22.

First, the laser power control section 12 receives a setting instruction signal b from the power setting section 11. The setting instruction signal b is output based on a user instruction or the like. For example, in the case where the optical disk apparatus 50 is an appliance which is capable of both recording and reproduction of information, the setting instruction signal b contains an instruction (reference voltage) which sets a power that corresponds to an operation (recording operation or reproduction operation) which is selected by the user. In the case where the optical disk apparatus 50 is a read-only appliance, or where playback is to be performed in a camcorder, the setting instruction signal b contains an instruction (reference voltage) which sets a power that corresponds to a playback operation (normal playback operation, fast playback operation, etc.) which is selected by the user.

Now, with reference to FIG. 7, the specific construction of the power setting section 11 and the laser power control section 12 will be described. FIG. 7 shows the functional block construction of the power setting section 11 and the laser power control section 12. The power setting section 11 includes a first reference voltage source 121a and a second reference voltage source 121b, and a switch 122. The first reference voltage source 121a and the second reference voltage source 121b are voltage sources which are capable of providing reference voltages for obtaining emission powers that are necessary for recording and reproduction, respectively, of information for the optical disk 60. The switch 122 connects one of the voltage sources to the differential amplifier 123 depending on recording or reproduction.

The laser power control section 12 includes a differential amplifier 123. The differential amplifier 123 is connected to the current-voltage converter 8, and receives the power detection signal a, which is represented as a voltage value. The differential amplifier 123 is connected to one of the first reference voltage source 121a and the second reference voltage source 121b to receive a reference voltage which serves as an operation reference.

The differential amplifier 123 receives a voltage corresponding to the power detection signal a and a reference voltage from a voltage source in the power setting section 11 corresponding to the setting instruction signal b. After a difference therebetween is calculated and amplified, it is output as a voltage signal Vk and sent to the laser driving section 20. This voltage signal Vk is utilized as a voltage for the laser driving section 20 to adjust the driving current to flow through the semiconductor laser 1. In other words, the laser power control section 12 can be regarded as controlling the current amount (current value) of the driving current for causing the semiconductor laser 1 to emit light. Note that, while the semiconductor laser 1 is emitting light, the power detection signal a is always sent to the laser power control section 12 and a power control based on the power detection signal a is performed, and the laser power control section 12 operates in such a manner that the power detection signal a equals the reference voltage signal. As a result, the current amount of the driving current which is supplied from the laser driving section 20 to the semiconductor laser 1 can be controlled (adjusted), whereby the emission power of the semiconductor laser 1 is appropriately controlled to a level which is necessary for the operation. Note that the construction of the laser power control section 12 shown in FIG. 7 is exemplary, and there is no limitation to this particular construction.

Next, referring back to FIG. 6, the temperature detecting section 21 and the voltage control section 22 will be described. The temperature detecting section 21 detects a temperature in the surroundings of the semiconductor laser 1, and supplies information which is in accordance with the detected temperature to the voltage control section 22. As will be described later, the temperature detecting section 21 is a thermistor in the present embodiment. Since a thermistor has a resistance value which changes with temperature, the change in its resistance value serves as the information to be provided to the voltage control section 22. Note that FIG. 6 illustrates the temperature detecting section 21 as being distant from the semiconductor laser 1, only for convenience of illustration. The temperature detecting section 21 is disposed near the package of the semiconductor laser 1, for example.

As will be described below, the aforementioned temperature detecting section 21 plays a prominent role in driving the semiconductor laser 1. However, the temperature detecting section 21 does not need to be a dedicated component element for implementing the present invention, because, in a general apparatus which employs a semiconductor laser (e.g., an optical head and an optical disk apparatus incorporating such an optical head), an element for temperature detection is already mounted for other purposes as will be exemplified below. Therefore, it can be said that the temperature detecting section 21 of the present embodiment makes use of an already-existing component element in the optical head. Therefore, the temperature detecting section 21 does not need to be provided in the laser driving device 10. In other words, the laser driving device 10 does not need to include the temperature detecting section 21 as its own component element. It suffices if the temperature detecting section 21 is provided within the optical head 52.

Examples where a temperature detection element may be mounted on an optical head are as follows. Since a semiconductor laser is liable to destruction or deterioration during a high-temperature operation, it is necessary to stop a reproduction or recording operation in times of a high temperature. Therefore, a temperature detection element is provided so as to be used for detecting the temperature in the surroundings of the semiconductor laser and ensuring protection thereof.

Moreover, in an optical disk apparatus, the emission power which is optimum for reproduction or recording of information and the optimum recording strategy for laser light generally vary depending on temperature. For this reason, a temperature detection element is provided so as to be used for correcting the emission power or recording strategy depending on the detected temperature (for example, Japanese Laid-Open Patent Publication No. 7-182721 and Japanese Laid-Open Patent Publication No. 2001-297437).

The voltage control section 22 supplies a source voltage Vc to the laser driving section 2. The source voltage Vc is a voltage which is necessary for driving the laser driving section 20 and the semiconductor laser 1. More specifically, in accordance with the temperature which is detected by the temperature detecting section 21, the voltage control section 22 adaptively changes the voltage Vc to be supplied to the laser driving section 2. The voltage control section 22 controls the voltage Vc, at a relatively low temperature, so as to be increased, and controls the voltage Vc, at a relatively high temperature, so as to be decreased.

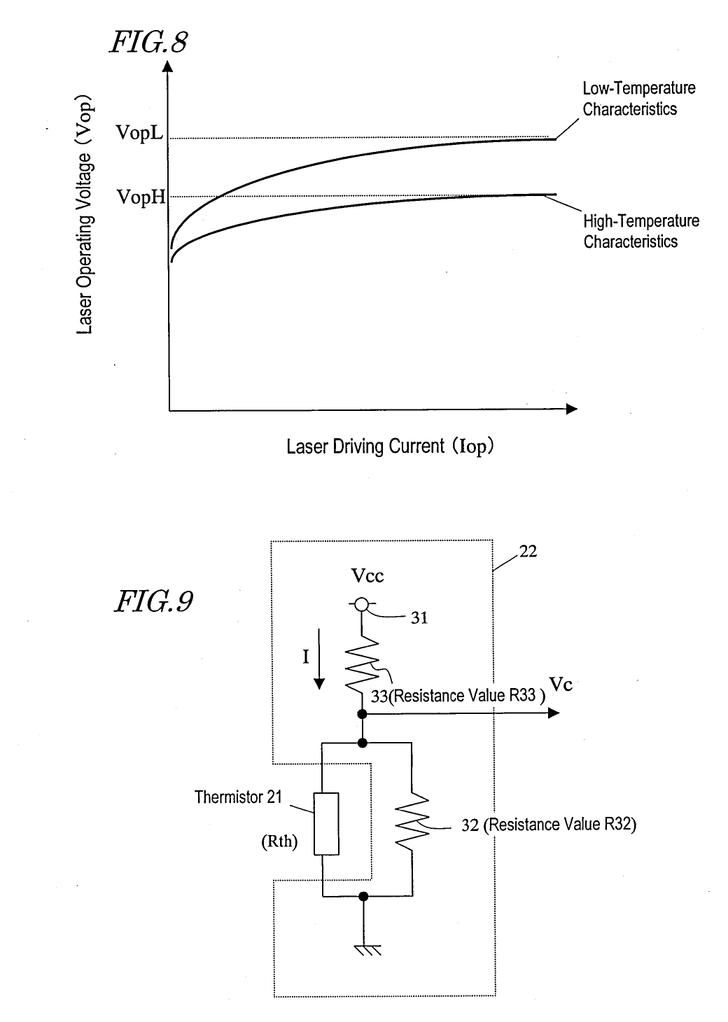

Now, in order to describe the operation principles of the temperature detecting section 21 and the voltage control section 22, the temperature dependence of an operating voltage of a commonly-used laser light source which includes the semiconductor laser 1 will be described. It is known that, in a blue-violet laser having a wavelength of 400 to 430 nm, the laser operating voltage increases as the temperature becomes lower (e.g., “Optronics Magazine”, 2003 May issue, The Optronics Co., Ltd., P121). FIG. 8 is a graph showing the laser driving current-laser operating voltage characteristics (Iop−Vop characteristics) of a blue-violet semiconductor laser with respect to temperature. The operating voltage of the semiconductor laser depends largely on temperature.

Specifically, when the temperature within the package of the semiconductor laser is relatively high (e.g., about 40° C.), the laser operating voltage (Vop) stays at a relatively low value (VopH) or below. On the other hand, when the temperature within the package of the semiconductor laser is relatively low (e.g., about 20° C.), the laser operating voltage becomes drastically high, with its value becoming greater than the aforementioned value of VopH. As shown by the laser driving current-laser emission power characteristics A (Iop-P characteristics A) in FIG. 2, when an emission power (P) of the semiconductor laser 1 is identified, a driving current (Iop) which gives that power is identified. However, the value of the operating voltage (Vop) for obtaining that driving current (Iop) will vary depending on the temperature of the semiconductor laser 1.

In the present embodiment, by taking these facts into consideration, the voltage control section 22 operates in accordance with the temperature which is detected in the temperature detecting section 21, as follows. At a high temperature, the voltage control section 22 controls the output voltage Vc so that a voltage Vc obtained as

Vc=VopH+Vtr (Formula 3)

is supplied to the laser driving section 2. In formula 3, “Vtr” is a voltage which is necessary for the laser driving section 2 to operate. Similarly, at a low temperature, the voltage control section 22 controls the output voltage Vc so that a voltage Vc obtained as

Vc=VopL+Vtr (Formula 4)

is supply to the laser driving section 2. Specific examples of these voltage values are: VopH=4.5V, VopL=6.5V, Vtr=2V.

From the standpoint of ensuring operation regardless of a low temperature or a high temperature, Vc as shown by formula 4 may always be supplied. However, by supplying a voltage Vc as obtained by formula 3 in times of a high temperature, a power reduction by (VopL−VopH)×Iop is possible.

In the present specification, the value of the output voltage Vc of the voltage control section 22 is controlled between two steps, i.e., an operating voltage VopH shown by formula 3 and an operating voltage VopL shown by formula 4. However, “two steps” is only exemplary. A greater number of steps may be used, or the value of the output voltage Vc may be controlled in a stepless manner in accordance with temperature. The latter control can be realized by, for example, previously sampling the operating voltage of the semiconductor laser 1 at each temperature and with respect to each size of driving current (Iop) that is needed, and store them in a table or the like. Once the size of the driving current (Iop) and the temperature of the semiconductor laser 1 at that time are identified, an operating voltage (Vop) can be obtained by referring to that table. By substituting this value in VopL in formula 3 (or VopH in formula 4), the voltage Vc at that time is identified.

As mentioned earlier, the temperature detecting section 21 does not need to be provided as a dedicated element on the optical head 52. Therefore, power savings can be realized without requiring any new component elements.

Although the temperature mentioned above is supposed to be a temperature within the package of the semiconductor laser, this temperature may vary depending on the temperature of the surrounding environment in which the package is installed. In the case where the package is provided within a drive device of an optical disk apparatus or the like, the temperature of the package would be equivalent to the room temperature drive in an environment where the device is not operating, e.g., immediately after activation of the drive device. However, once the drive device is activated and a predetermined period has elapsed, the temperature of the package will be higher than the room temperature by about 10 to 20° C. Therefore, it is well possible that a difference of about 20° C. may emerge between the intra-package temperature immediately after activation and the intra-package temperature after the lapse of a certain period or more.

Next, constructions for realizing the above-described operation will be described. FIG. 9 shows the circuit construction of the temperature detecting section 21 and the voltage control section 22. In FIG. 9, what has been referred to as the temperature detecting section 21 is shown as a “thermistor 21”.

On the other hand, the voltage control section 22 includes a power source 31 and resistors 32 and 33. The resistor 32 is connected in parallel to the thermistor 21. One end of each of the resistor 32 and the thermistor 21 is connected to one end of the resistor 33. From within this connection path, the voltage Vc of the voltage control section 22 is taken out for output. The other ends of the resistor 32 and the thermistor 21 are connected to ground. On the other hand, the power source 31 (voltage value Vcc) is connected to the other end of the resistor 33.

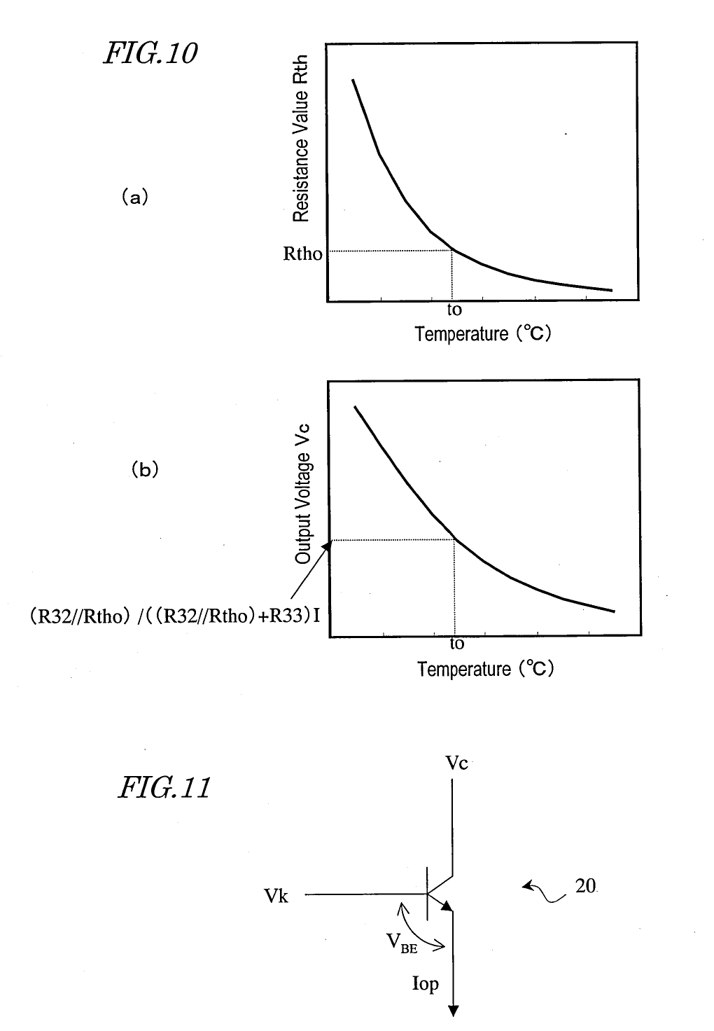

FIG. 10(a) shows the temperature characteristics of a resistance value Rth of the thermistor 21. The thermistor 21 has its resistance value Rth increased as the temperature decreases, and has its resistance value Rth decreased as the temperature increases.

On the other hand, FIG. 10(b) shows the temperature characteristics of an output voltage of the voltage control section 22. When the resistance value of the resistor 33 is represented as R33, and so on, and the size of the current flowing through the resistor 33 is represented as I, the output voltage Vc of the voltage control section 22 is obtained as:

Vc=(R32//Rtho)/[(R32//Rtho)+R33]·I. (Formula 5)

From FIG. 10(b), it is understood that the output voltage Vc increases as the temperature decreases, and the output voltage Vc decreases as the temperature increases.

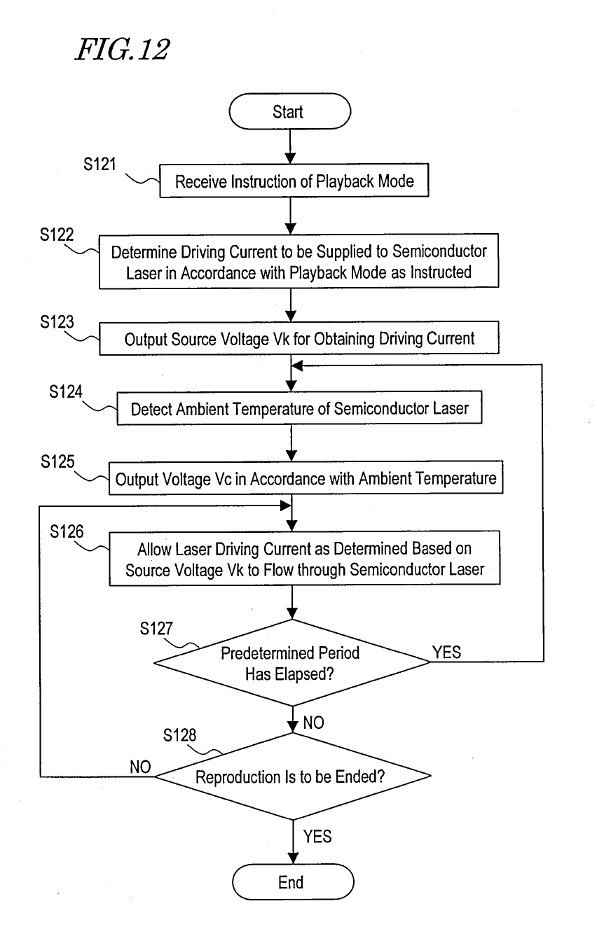

Next, a specific construction of the laser driving section 20 shown in FIG. 6 will be described. FIG. 11 shows the construction of the laser driving section 20. The laser driving section 20 can be implemented as a transistor. A collector terminal of the transistor 20 is connected to the voltage control section 22, whose output voltage Vc is applied to the collector terminal. A base terminal of the transistor 20 is connected to the laser power control section 12, whose output voltage Vk is applied to the base terminal. An emitter terminal of the transistor 20 is connected to an anode terminal of the semiconductor laser 1. A current Iop which flows through the semiconductor laser 1 from the base terminal and via the emitter terminal is obtained as:

Iop=(Vk−VBE)/z. (Formula 6)

Note that “VBE” is a voltage between the base and the emitter, whereas z is an impedance of the laser. According to formula 6, it is understood that the current Iop is controlled by the output voltage Vk of the laser power control section 12, and is not controlled by the output voltage Vc of the voltage control section 22.

Note that, as a technique for improving the recording and/or reproduction quality, it might be conceivable to detect the ambient temperature of the semiconductor laser 1 and change the voltage Vk in the power setting section 11 and the laser power control section 12. This technique would be effective for the adjustment of the voltage Vk which is applied to the base terminal of the laser driving section 20 as well as the driving current which is defined according to this voltage. On the other hand, the voltage Vc is applied to the collector terminal of the laser driving section 20, and therefore is independent of the aforementioned voltage Vk. Therefore, it still holds true that adjusting the voltage Vc to its lowest limit that permits operation is advantageous in terms of power consumption. Note that the laser driving section 20 is not limited to a transistor, but may be any component element that is capable of controlling the current to be supplied to the semiconductor laser 1 in accordance with the output value of the laser power control section 20.

Next, with reference to FIG. 12, the processing by the optical disk apparatus 50 operating based on the above-described principle will be described. FIG. 12 shows a procedure of processing by the optical disk apparatus 50.

First, at the beginning of the operation of the optical disk apparatus 50 or the like, at step S121, the power setting section 11 receives an instruction of a playback mode from the user, e.g., a normal playback mode, a fast playback mode, or the like. At the next step S122, in accordance with this playback mode, the power setting section 11 determines a driving current to be supplied to the semiconductor laser, and outputs a setting instruction for obtaining that driving current. At step S123, the laser power control section 12 outputs a voltage Vk for causing the driving current, based on the setting instruction signal b.

On the other hand, the temperature detecting section 21 detects the ambient temperature of the semiconductor laser 1 at step S124, and then at step S125, the voltage control section 22 outputs a voltage Vc which is in accordance with the ambient temperature. This voltage is a necessary and sufficient voltage for the semiconductor laser 1 to emit light, and is not to be applied in excess. At step S126, the laser driving section 20 allows a laser driving current which is determined based on the voltage Vk to flow through the semiconductor laser 1, whereby the semiconductor laser 1 emits light.

At step S127, it is determined by the laser driving device 10 as to whether a predetermined period has elapsed or not. If the predetermined period has elapsed, control returns to step S124 to detect the ambient temperature of the semiconductor laser 1. If the predetermined period has not elapsed, control proceeds to step S128.

The reason why this step S127 is provided is in order to perform a more flexible laser driving control. The “predetermined period” refers to a timing with which temperature is detected by the temperature detecting section 21, and does not need to be a fixed value. For example, within five minutes from the beginning of the operation of the optical disk apparatus 50, the “predetermined period” may be set at every one minute, whereas after five minutes from the beginning of operation, the “predetermined period” may be set at every five minutes. Immediately after the beginning of operation, the temperature of the semiconductor laser 1 is detected relatively frequently because the temperature begins to increase. On the other hand, after about five minutes since the beginning of operation, the temperature change is believed to substantially converge; hence, the temperature of the semiconductor laser 1 may be detected with a relatively low frequency thereafter.

At step S128, it is determined by the laser driving device 10 as to whether reproduction is to be ended or not. If reproduction is to be continued, control returns to step S126, and the laser driving section 20 continues to allow a driving current to flow through the semiconductor laser 1. On the other hand, if reproduction is to be ended, the driving current is cut off so that the semiconductor laser 1 stops emitting light, and the process ends. Note that the determination at step S128 can be made based on, for example, whether or not an instruction to stop power supplying, etc., is given to the power setting section 11.

Through the above processing procedure, the laser driving device 10 is able to make a necessary and sufficient use of a voltage which is necessary for driving the semiconductor laser 1. Therefore, at the optical head 52 having the laser driving device 10, or at the optical disk apparatus 50 in which the optical head 52 is mounted, a very effective power saving function can be provided. This power saving function is suitably applied to mobile-type optical disk apparatuses or the like, which are especially restricted in terms of available power.

With the above-described construction, since a temperature sensor or the like that is commonly mounted in an optical head is utilized as the temperature detecting section 21, it is possible to realize both laser emission at a low temperature and power savings at a high temperature, without requiring any new component elements.

Note that the construction according to the present embodiment where the output voltage Vc of the voltage control section 22 is controlled by using the temperature detecting section 21 is especially effective in a laser driving device which employs a blue-violet laser. The reason is that, firstly, fluctuations in the laser operating voltage of a blue-violet laser will receive very large influences of temperature as shown in FIG. 8, and therefore a significant effect on power savings can be obtained by controlling the voltage Vc so as to correspond to the temperature-induced changes in the laser operating voltage. Secondly, a blue-violet laser requires a greater band gap for laser emission, and hence a higher laser operating voltage, than does a red laser or the like. Therefore, a blue-violet laser is likely to have an increased power consumption over that of a red laser, and thus the requirements concerning power savings and temperature increases of the appliance (especially at a high temperature) are even greater than those for a red laser.

In FIG. 6, the power setting section 11 and the laser power control section 12 are illustrated as being provided within the laser driving device 10. However, they may be provided external to the laser driving device 10. For example, they may be provided within the optical head 52 but externally to the laser driving device 10, or provided within the optical disk apparatus 50 but externally to the optical head 52.

Although the present embodiment illustrates an example where the temperature detecting section 21 and the voltage control section 22 are constructed by combining the thermistor 31 and the resistors 32 and 33, these are no limitations. An IC chip may be used as the thermistor 21, and a programmable power source may be used as a voltage control section.

Although the present embodiment illustrates an example where the cathode terminal of the semiconductor laser is grounded, it will be appreciated that similar effects can also be obtained in the case where the anode terminal is connected to the power source.

### INDUSTRIAL APPLICABILITY

According to the present invention, provided is a driving device for a semiconductor laser which enables to reduce power consumption without requiring any new component elements. An appliance having the driving device according to the present invention will make energy savings possible, and further suppress temperature increases. As such an appliance, for example, an optical disk apparatus which performs data write and read operation with respect to an optical disk by using a blue-violet laser light would be suitable. In particular, a mobile-type appliance (e.g., a mobile optical disk apparatus) which is under severe requirements concerning temperature increase suppression and power savings of the appliance would be suitable.

1. A laser driving device comprising:
a laser driving section for supplying a driving current for causing a laser to emit light;
a temperature detecting section for detecting a temperature of the laser; and
a voltage control section for supplying a source voltage to the laser driving section while changing a voltage value of the source voltage in accordance with the temperature detected by the temperature detecting section,
wherein the laser driving section and the laser become operable with supply of the source voltage, and the laser driving section supplies the driving current based on an instruction value which is different from the voltage value of the source voltage.

2. The laser driving device of claim 1, further comprising a power control section for causing the laser to emit the light with a predetermined emission power by controlling the instruction value for the laser driving section so as to adjust the driving current supplied from the laser driving section.

3. The laser driving device of claim 2, further comprising a setting section for instructing a setting of a reference voltage in accordance with an amount of light to be emitted by the laser.

4. The laser driving device of claim 2, further comprising an emission power detecting section for detecting a value which is in accordance with the emission power of the laser and for outputting a signal corresponding to the value,
wherein the power control section controls an instruction value to the laser driving section based on a voltage of the signal output from the emission power detecting section, and the reference voltage, in such a manner that the voltage of the signal equals the reference voltage.

5. The laser driving device of claim 4, wherein,
characteristics between an operating voltage, which is necessary for the laser to operate, and the driving current differ depending on temperature; and
the voltage control section determines the voltage value of the source voltage based on the driving current and the characteristics.

6. The laser driving device of claim 5, wherein,
the operating voltage increases as the temperature decreases; and
the voltage control section supplies a higher source voltage as the temperature decreases.

7. The laser driving device of claim 1, wherein the laser driving section outputs the driving current for causing a laser whose wavelength is within a range from 400 nm to 430 nm to emit light.

8. An optical head for performing a data write and/or read operation with respect to an information recording layer of a storage medium, comprising:
a laser;
a laser driving device for supplying a driving current for causing the laser to emit light;
an objective lens for converging light from the laser onto the information recording layer; and
a light-receiving section for receiving light reflected from the information recording layer and for outputting a signal which is in accordance with the amount of light, wherein,
the laser driving device includes:
a laser driving section for supplying a driving current for causing the laser to emit light;
a temperature detecting section for detecting a temperature of the laser; and
a voltage control section for supplying a source voltage to the laser driving section while changing a voltage value of the source voltage in accordance with the temperature detected by the temperature detecting section, wherein the laser driving section and the laser become operable with supply of the source voltage, and the laser driving section supplies the driving current based on an instruction value which is different from the voltage value of the source voltage.

9. An optical disk apparatus for performing a data write and/or read operation with respect to an information recording layer of an optical disk, comprising:
an optical head for radiating light toward the optical disk, and generating and outputting a servo signal based on light reflected from the information recording layer;
a control signal generating section for generating a control signal for controlling a position of a focal point of the light based on the servo signal output from the optical head; and
a driving circuit for generating a driving signal based on the control signal, wherein, the optical head includes:
a laser;
a laser driving device for supplying a driving current for causing the laser to emit light;
an objective lens for converging light from the laser onto the information recording layer;
an actuator for adjusting a position of the objective lens based on the driving signal; and
a light-receiving section for receiving light reflected from the information recording layer and for outputting a signal which is in accordance with the amount of light, wherein, the laser driving device includes:
a laser driving section for supplying a driving current for causing the laser to emit light;
a temperature detecting section for detecting a temperature of the laser; and
a voltage control section for supplying a source voltage to the laser driving section while changing a voltage value of the source voltage in accordance with the temperature detected by the temperature detecting section, wherein the laser driving section and the laser become operable with supply of the source voltage, and the laser driving section supplies the driving current based on an instruction value which is different from the voltage value of the source voltage.

10. A laser driving method comprising the steps of:
supplying a driving current for causing a laser to emit light;
detecting a temperature of the laser; and
supplying a source voltage when executing the step of supplying the driving current, a voltage value of the source voltage being changed in accordance with the detected temperature, wherein the step of supplying the driving current and the laser emission based on the driving current become operable with supply of the source voltage, and the step of supplying the driving current supplies the driving current based on an instruction value which is different from the voltage value of the source voltage.
